(19) United States
(12) Patent Application Publication
(10) Pub. No.: US 2006/0269843 A1
(43) Pub. Date: Nov. 30, 2006

(54) Nonaqueous electrolyte and nonaqueous electrolyte secondary battery using the same

(75) Inventors: Kyohei Usami, Kariya-shi (JP); Atsushi Fukaya, Kariya-shi (JP); Manabu Yamada, Kariya-shi (JP); Takayuki Taki, Tokyo (JP); Kohei Yamamoto, Kariya-shi (JP)

Correspondence Address: YOUNG & THOMPSON, 745 SOUTH 23RD STREET, 2ND FLOOR, ARLINGTON, VA, 22202, US

(73) Assignees: DENSO CORPORATION, KARIYA-SHI (JP); ADEKA CORPORATION, TOKYO (JP)

(21) Appl. No.: 11/441,007

(22) Filed: May 26, 2006

(30) Foreign Application Priority Data
May 30, 2005 (JP) 2005-156763
Apr. 26, 2006 (JP) 2006-122217

(51) Int. Cl. H01M 10/40

(52) U.S. Cl. 429/324

(57) ABSTRACT

A nonaqueous electrolyte containing a silicon compound of formula (1) or (2) and a nonaqueous electrolyte secondary battery using the nonaqueous electrolyte and excellent in cycle characteristics and low temperature characteristics, 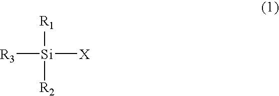
wherein R₁ and R₂ each represent alkyl, cycloalkyl, alkoxy or halogen; R₃ represents alkenyl; and X represents halogen, 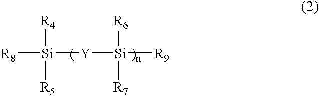
wherein R₄, R₅, R₆, and R₇ each represent alkyl, alkoxy, alkenyl, alkenyloxy, alkynyl, alkynyloxy, phenyl or phenoxy, each of which may have an ether bond in its chain; R₈ represents halogen, halogen-substituted aryl, alkenyl, alkynyl, cycloalkyl, cycloalkenyl; a trifluoromethyl group, an acyloxy group having 5 to 8 carbon atoms, a sulfonate group having 1 to 8 carbon atoms, an isocyanyl group an isothianyl or a cyano group, R₉ represents halogen, a trifluoromethyl group,an acyloxy group having 5 to 8 carbon atoms, a sulfonate group having 1 to 8 carbon atoms, an isocyanyl group an isothianyl or a cyano group: halogen-substituted aryl; n represents 1 or 2; and Y represents a single bond, oxygen, alkylene, alkylenedioxy, alkenylene, alkenylenedioxy, alkynylene, alkynylenedioxy, arylene or arylenedioxy; provided that the number of groups having an unsaturated bond in R₄, R₅, R₆, R₇, R₈, and R₉ is zero or one.

### FIELD OF THE INVENTION

This invention relates to a nonaqueous electrolyte containing a silicon compound having a specific structure and a nonaqueous electrolyte secondary battery using the same. More particularly, it relates to a nonaqueous electrolyte which, as assembled into a secondary battery, maintains a high electrical capacity with reduced changes in electrical capacity and internal resistance against charge/discharge cycling and with a reduced increase in internal resistance in low temperatures and thus provides a battery excellent in cycle characteristics and low temperature characteristics; and a nonaqueous electrolyte secondary battery using the nonaqueous electrolyte.

### BACKGROUND OF THE INVENTION

With the recent spread of portable electronic equipment such as notebook computers and video camcorders, nonaqueous electrolyte secondary batteries having high voltage and high energy density have come to be used widely as a power source. From the concern for the environmental protection, electric-powered vehicles and hybrid-powered vehicles utilizing electric batteries as a part of motive power have already been put to practical use.

The problem of the state-of-the-art nonaqueous secondary batteries is insufficient reliability as a stable source of power because they undergo a reduction in electrical capacity or an increase in internal resistance with charge/discharge cycles or in low temperatures.

Various additives have been proposed to improve the stability or electrical characteristics of nonaqueous electrolyte secondary batteries. For example, Patent Document 1 and Patent Document 2 disclose a secondary battery containing a silicon compound having an unsaturated bond or a silicon compound having a fluorine atom. However, the battery is still unsatisfactory in long-term use stability and low temperature characteristics. Patent Document 3, Patent Document 4, and Patent Document 5 propose a nonaqueous secondary battery containing a fluorinated silane compound having a specific structure.

Patent Document 1: JP-A-2002-134169

Patent Document 2: JP-A-2004-39510

Patent Document 3: JP-A-2002-33127

Patent Document 4: JP-A-2004-87459

Patent Document 5: JP-A-2004-171981

### SUMMARY OF THE INVENTION

An object of the present invention is to provide a nonaqueous electrolyte which, as assembled into a secondary battery, maintains a high electrical capacity with reduced changes in electrical capacity and internal resistance against charge/discharge cycling and with a reduced increase in internal resistance in low temperatures and thus provides a battery excellent in cycle characteristics and low temperature characteristics.

Another object of the invention is to provide a nonaqueous electrolyte secondary battery excellent in cycle characteristics and low temperature characteristics.

As a result of extensive investigations, the present inventors have found that the objects of the invention are accomplished by adding to an electrolyte a silicon compound having a specific structure.

The present invention provides in a first aspect a nonaqueous electrolyte having an electrolyte salt dissolved in an organic solvent and containing at least one silicon compound represented by formula (1) or (2) shown below. The invention also provides in a second aspect a nonaqueous electrolyte secondary battery containing the nonaqueous electrolyte as an electrolyte solution.

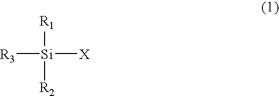

wherein R₁ and R₂ each represent an alkyl group having 1 to 10 carbon atoms, a cycloalkyl group having 5 to 8 carbon atoms, an alkoxy group having 1 to 10 carbon atoms or a halogen atom; R₃ represents an alkenyl group having 13 to 20 carbon atoms; and X represents a halogen atom. 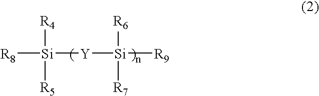
wherein R₄, R₅, R₆, and R₇ each represent an alkyl group having 1 to 10 carbon atoms, an alkoxy group having 1 to 10 carbon atoms, an alkenyl group having 2 to 10 carbon atoms, an alkenyloxy group having 2 to 10 carbon atoms, an alkynyl group having 2 to 8 carbon atoms, an alkynyloxy group having 2 to 8 carbon atoms, a phenyl group or a phenoxy group, each of which may have an ether bond in its chain; R₈ represents a halogen atom, a halogen-substituted aryl group, an alkenyl group having 2 to 20 carbon atoms, an alkynyl group having 2 to 8 carbon atoms, a cycloalkyl group having 5 to 8 carbon atoms, a cycloalkenyl group having 5 to 8 carbon atoms; a trifluoromethyl group, an acyloxy group having 5 to 8 carbon atoms, a sulfonate group having 1 to 8 carbon atoms, an isocyanyl group an isothianyl or a cyano group, R₉ represents a halogen atom, a halogen-substituted aryl group; a trifluoromethyl group, an acyloxy group having 5 to 8 carbon atoms, a sulfonate group having 1 to 8 carbon atoms, an isocyanyl group an isothianyl or a cyano group, n represents 1 or 2; and Y represents a single bond, an oxygen atom, an alkylene group, an alkylenedioxy group, an alkenylene group, an alkenylenedioxy group, an alkynylene group, an alkynylenedioxy group, an arylene group or an arylenedioxy group; provided that the number of groups having an unsaturated bond in R₄, R₅, R₆, R₇, R₈, and R₉ is zero or one.

The nonaqueous electrolyte of the present invention provides a nonaqueous electrolyte secondary battery superior in charge/discharge cycle characteristics and low temperature characteristics.

### BRIEF DESCRIPTION OF THE DRAWINGS

FIG. 1 is a schematic cross-sectional view of an example of a coin-shaped nonaqueous electrolyte secondary battery according to the present invention.

FIG. 2 schematically illustrates the basic structure of a cylindrical nonaqueous electrolyte secondary battery according to the present invention.

FIG. 3 is a perspective view, with parts exploded and parts in cross-section, illustrating a cylindrical nonaqueous electrolyte secondary battery according to the present invention.

### DETAILED DESCRIPTION OF THE INVENTION

In formulae (1) and (2), the alkyl group having 1 to 10 carbon atoms as represented by R₁, R₂, R₄, R₅, R₆, and R₇ includes methyl, ethyl, propyl, butyl, sec-butyl, tert-butyl, pentyl, hexyl, heptyl, octyl, 2-ethylhexyl, nonyl, and decyl. The alkoxy group having 1 to 10 carbon atoms includes those derived from the recited alkyl groups having 1 to 10 carbon atoms. The alkenyl group having 2 to 10 carbon atoms as represented by R₄, R₅, R₆, and R₇ includes vinyl, allyl, 1-propenyl, isopropenyl, 2-butenyl, 1,3-butadienyl, 2-pentenyl, 2-octenyl, nonenyl, and decenyl. The alkenyloxy group having 2 to 10 carbon atoms includes those derived from the recited alkenyl groups having 2 to 10 carbon atoms. The alkynyl group having 2 to 8 carbon atoms as represented by R₄, R₅, R₆, R₇, and R₈ includes ethynyl, 2-propynyl, and 1,1-dimethyl-2-propynyl. The alkynyloxy group having 2 to 8 carbon atoms as represented by R₄, R₅, R₆, and R₇ includes those derived from the recited alkynyl groups having 2 to 8 carbon atoms. The alkenyl group having 13 to 20 carbon atoms as represented by R₃ includes tridecenyl, tetradecenyl, pentadecenyl, hexadecenyl, heptadecenyl, octadecenyl, nonadecenyl, and icosenyl. The cycloalkyl group having 5 to 8 carbon atoms as represented by R₁, R₂, and R₈ includes cyclopentyl, cyclohexyl, cycloheptyl, cyclooctyl, and 2-norbornyl. The cycloalkenyl group having 5 to 8 carbon atoms as represented by R₈ includes cyclopentenyl, cyclohexenyl, cycloheptenyl, cyclooctenyl, and 2-norbomenyl. The halogen atom as represented by X, R₁, R₂, R₈, and R₉ includes fluorine, chlorine, bromine, and iodine. The acyloxy group having 5 to 8 carbon atoms as represented by R₈ and R₉ includes acetoxy, propyloxy, trifluoroactoxy, difluoroacetoxy, the sulfonate group having 1 to 8 carbon atoms as represented by R₈ and R₉ includes methane sulfonate, ethane sulfonate, propane sulfonate, butane sulfonate, pentane sulfonate, hexane sulfonate, heptane sulfonate, octane sulfonate, trifluoromethane sulfonate, pentafluoroethane sulfonate, hexafluoropropane sulfonate, perfluorobutane sulfonate, perfluoropentane sulfonate, perfluorohexane sulfonate, perfluoroheptane sulfonate, perfluorooctane sulfonate. The alkylene group and the alkylenedioxy group as represented by Y include alkylene groups having 1 to 8 carbon atoms, such as methylene, ethylene, trimethylene, 2,2-dimethyltrimethylene, tetramethylene, pentamethylene, and hexamethylene; and alkylenedioxy groups derived from these alkylene groups. The alkenylene group and alkenylenedioxy group include alkenylene groups having 2 to 8 carbon atoms, such as vinylene, propenylene, isopropenylene, butenylene, and pentenylene; and alkenylenedioxy groups derived therefrom. The alkynylene group and alkynylenedioxy group include alkynylene groups having 2 to 8 carbon atoms, such as ethynylene, propynylene, butynylene, pentynylene, and 1,1,4,4-tetramethylbutynylene; and alkynylenedioxy groups derived therefrom. Examples of the arylene group and arylenedioxy group include arylene groups having 6 to 12 carbon atoms, such as phenylene, methylphenylene, dimethylphenylene, and tert-butylphenylene; and arylenedioxy groups derived therefrom.

Specific examples of the silicon compounds represented by formulae (1) and (2) are include compound Nos 1 through 25 listed below for illustrative purposes only but not for limitation.

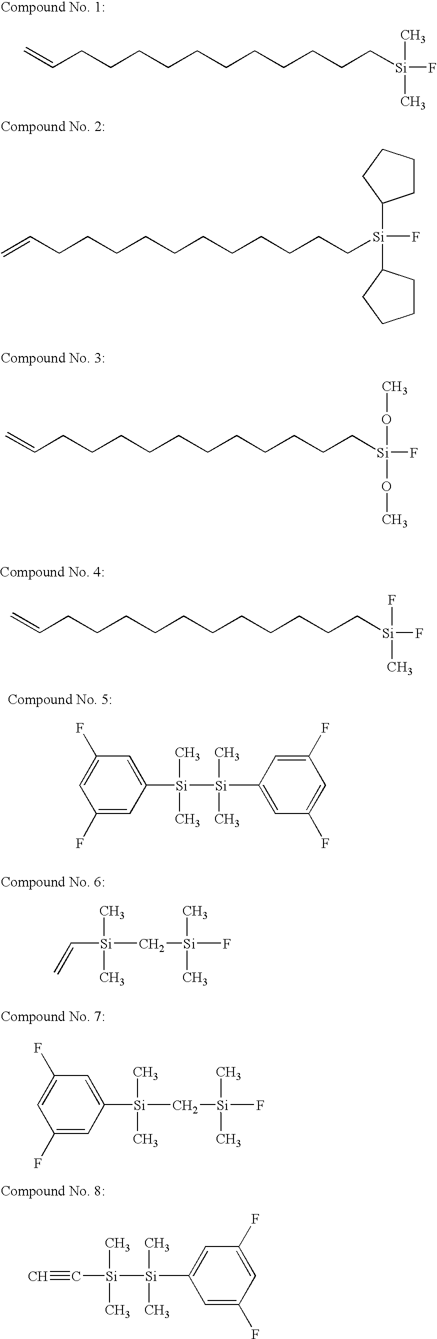

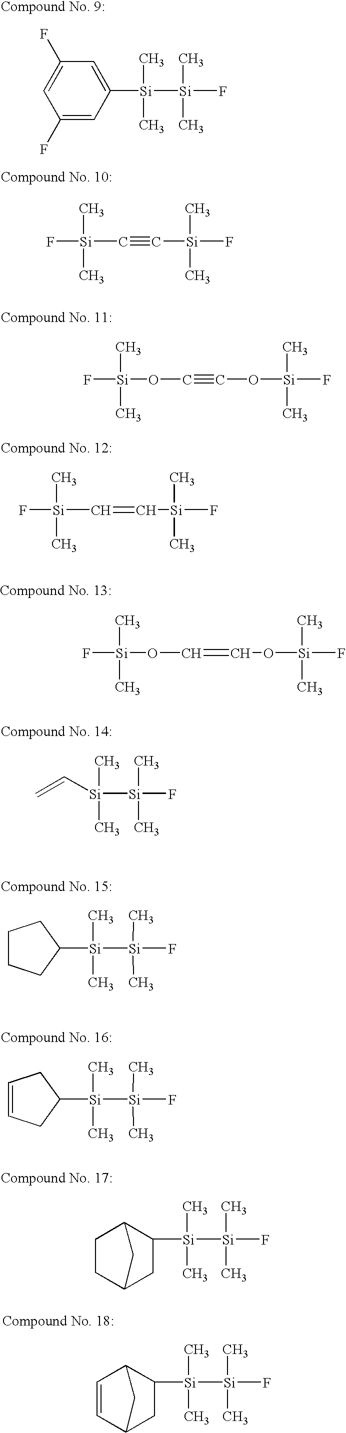

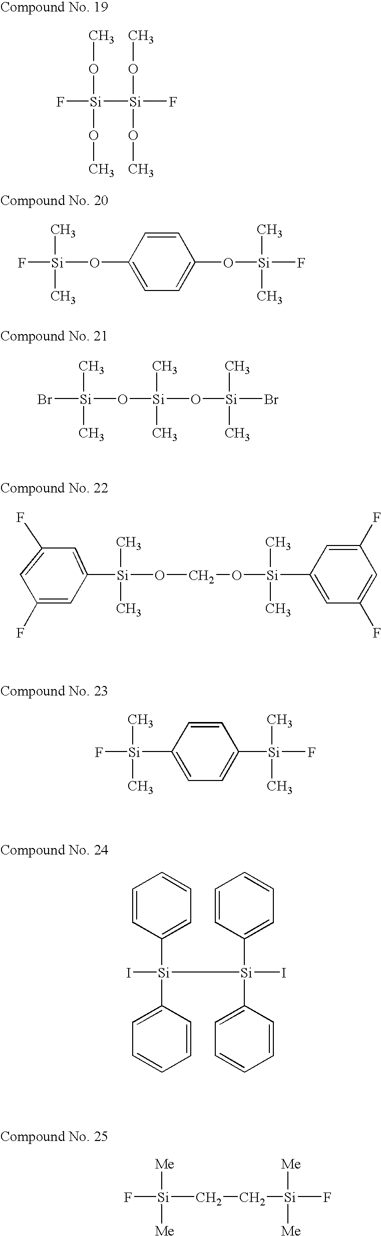

The silicon compound of the invention self-polymerizes easily. It is considered that the compound self-polymerizes on the electrode interface to form a stable film in the initial stage of charge/discharge cycling thereby suppressing an increase in interfacial resistance with the number of charge/discharge cycles. A desirable amount of the silicon compound in the nonaqueous electrolyte to produce the above-described effect is 0.05% to 5% by volume, preferably 0.1% to 3% by volume. At amounts less than 0.05% by volume, the resultant effect may be insubstantial. Addition of more than 5% by volume produces no further effects, which not only results in waste but rather adversely affects the characteristics of the electrolyte.

In preparing the nonaqueous electrolyte of the invention, the silicon compound is added to an organic solvent. Any one or more of organic solvents commonly employed in nonaqueous electrolytes can be used. It is preferred for the nonaqueous electrolyte to contain as a solvent at least one compound selected from the group consisting of a cyclic carbonate compound, an acyclic carbonate compound, a cyclic ester compound, an acyclic ester compound, a sulfone or sulfoxide compound, an amide compound, an acyclic ether compound, and a cyclic ether compound. A mixed solvent containing a combination of at least one cyclic carbonate compound and at least one acyclic carbonate compound is particularly preferred. The nonaqueous electrolyte of the invention using the combination of solvents has a proper viscosity and provides a secondary battery excellent in not only cycle characteristics but balance with other properties such as electrical capacity and output.

The organic solvents that can be used in the nonaqueous electrolyte of the invention will be described in more detail with their exemplary but not limiting examples.

The cyclic carbonate compound, cyclic ester compound, sulfone or sulfoxide compound, and amide compound have a high dielectric constant and serve to increase the dielectric constant of the electrolyte. The cyclic carbonate compound includes ethylene carbonate (EC), propylene carbonate (PC), vinylene carbonate (VC), 1,2-butylene carbonate, isobutylene carbonate and vinylethylene carbonate. The cyclic ester compound includes γ-butyrolactone and γ-valerolactone. The sulfone or sulfoxide compound includes sulfolane, sulfolene, tetramethylsulfolane, diphenylsulfone, dimethylsulfone, and dimethyl sulfoxide, with sulfolanes being preferred. The amide compound includes N-methylpyrrolidone, dimethylformamide, and dimethylacetamide.

The acyclic carbonate compound, acyclic ether compound, cyclic ether compound, and acyclic ester compound are capable of decreasing the viscosity of the nonaqueous electrolyte. Therefore, use of these solvents results in improving electrolyte ion mobility and battery performance properties such as power density. To have a low viscosity also leads to improvement in low temperature performance properties of the nonaqueous electrolyte. The acyclic carbonate compound includes dimethyl carbonate (DMC), ethylmethyl carbonate (EMC), diethyl carbonate (DEC), ethyl-n-butyl carbonate, methyl-t-butyl carbonate, diisopropyl carbonate, and t-butylisopropyl carbonate. The acyclic and cyclic ether compounds include dimethoxyethane (DME), ethoxymethoxyethane, diethoxyethane, tetrahydrofuran, dioxolane, dioxane, 1,2-bis(methoxycarbonyloxy)ethane, 1,2-bis(ethoxycarbonyloxy)ethane, 1,2-bis(ethoxycarbonyloxy)propane, ethylene glycol bis(trifluoroethyl) ether, isopropylene glycol trifluoroethyl ether, ethylene glycol bis(trifluoromethyl) ether, and diethylene glycol bis(trifluoroethyl) ether, with dioxolanes being preferred. The acyclic ester compound includes a carboxylic acid ester represented by formula (3): 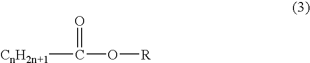
wherein R represents an alkyl group having 1 to 4 carbon atoms; and n represents 0, 1 or 2.

In formula (3), the alkyl group having 1 to 4 carbon atoms as represented by R includes methyl, ethyl, propyl, isopropyl, butyl, sec-butyl, and tert-butyl.

Examples of the carboxylic acid ester of formula (3) are methyl formate, ethyl formate, methyl acetate, ethyl acetate, propyl acetate, sec-butyl acetate, butyl acetate, methyl propionate, and ethyl propionate. The ester of formula (3) has a low solidification temperature and, when combined with other organic solvents, especially a mixed solvent of at least one cyclic carbonate compound and at least one acyclic carbonate compound, secures battery characteristics even in low temperatures. A preferred proportion of the carboxylic ester compound of formula (3) in a mixed organic solvent system is 1% to 50% by volume.

Additional examples of useful organic solvents include acetonitrile, propionitrile, and nitromethane, and derivatives thereof.

A flame retardant of halogen, phosphorus or other types can be added to the nonaqueous electrolyte of the invention as appropriate to provide a flame retardant electrolyte. Phosphorus flame retardants include phosphoric esters, such as trimethyl phosphate and triethyl phosphate.

The amount of the flame retardant to be added is preferably 5% to 100% by mass, still preferably 10% to 50% by mass, based on the total organic solvent of the electrolyte. Addition of less than 5% by mass of the flame retardant results in insubstantial flame retardation.

The electrolyte salts that can be used in the nonaqueous electrolyte of the invention is conventional. Exemplary electrolyte salts include LiPF₆, LiBF₄, LiAsF₆, LiCF₃SO₃, LiN(CF₃SO₂)₂, LiC(CF₃SO₂)₃, LiSbF₆, LiSiF₅, LiAlF₄, LiSCN, LiClO₄, LiCl, LiF, LiBr, LiI, LiAlF₄, LiAlCl₄, NaClO₄, NaBF₄, and NaI, and their derivatives. To secure electrical characteristics, it is preferred to use at least one of LiPF₆, LiBF₄, LiClO₄, LiAsF₆, LiCF₃SO₃, LiN(CF₃SO₂)₂, LiC(CF₃SO₂)₃, LiCF₃SO₃ derivatives, LiN(CF₃SO₂)₂ derivatives, and LiC(CF₃SO₂)₃ derivatives.

The electrolyte salt is preferably dissolved in the organic solvent in a concentration of 0.1 to 3.0 mol/l, still preferably 0.5 to 2.0 mol/l. At salt concentrations lower than 0.1 mol/l, the resulting battery can fail to have a sufficient current density. Salt concentrations higher than 3.0 mol/l can impair the stability of the nonaqueous electrolyte.

The nonaqueous electrolyte according to the present invention is suited for use in applications to primary and secondary batteries, particularly nonaqueous electrolyte secondary batteries hereinafter described.

The battery comprises a positive electrode and a negative electrode. The positive electrode includes a sheet electrode prepared by applying a slurry of a positive electrode active material, a binder, and an electroconductive material in an organic solvent or water to a current collector, followed by drying. Examples of the positive electrode active material include TiS₂, TiS₃, MoS₃, FeS₂, Li₍₁₋ₓ₎MnO₂, Li₍₁₋ₓ₎Mn₂O₄, Li₍₁₋ₓ₎CoO₂, Li₍₁₋ₓ₎NiO₂, LiV₂O₃, and V₂O₅ (wherein x is a number of 0 to 1). Preferred of these active materials are complex oxides of lithium and transition metals, such as LiCoO₂, LiNiO₂, LiMn₂O₄, LiMnO₂, LiV₂O₃, and LiFePO₄. Binders for the positive electrode active materials include, but are not limited to, polyvinylidene fluoride, polytetrafluoroethylene, EPDM, SBR, NBR, and fluororubber.

The negative electrode includes a sheet electrode prepared by applying a slurry of a negative electrode active material and a binder in an organic solvent or water to a current collector, followed by drying. The negative electrode active material includes lithium, lithium alloys, inorganic compounds such as tin compounds, carbonaceous materials, and electroconductive polymers. Carbonaceous materials capable of intercalating and deintercalating highly safe lithium ions are preferred. Exemplary examples of the carbonaceous materials include, but are not limited to, graphite, petroleum coke, coal coke, carbonized petroleum pitch, carbonized coal pitch, carbonized resins such as carbonized phenol resins and carbonized crystalline cellulose resins, carbon materials obtained by partially graphitizing the above-recited carbonaceous materials, furnace black, acetylene black, pitch-based carbon fiber, and PAN-based carbon fiber. Examples of the binders for the negative electrode active materials are the same as those enumerated for the positive electrode active materials.

The electroconductive material used in the positive electrode include, but is not limited to, fine particles of graphite, fme particles of amorphous carbon such as carbon blacks (e.g., acetylene black and Ketjen black) and needle coke, and carbon nanofiber. The solvent for preparing the active material slurry is usually chosen from organic solvents capable of dissolving the binder. Examples of useful organic solvents include, but are not limited to, N-methylpyrrolidone, dimethylformamide, dimethylacetamide, methyl ethyl ketone, cyclohexanone, methyl acetate, methyl acrylate, diethyltriamine, N,N-dimethylaminopropylamine, ethylene oxide, and tetrahydrofuran.

The current collector usually used in the negative electrode includes copper, nickel, stainless steel, and nickel-plated steel. The current collector usually used in the positive electrode includes aluminum, stainless steel, and nickel-plated steel.

A separator is interposed between the positive and negative electrodes in the nonaqueous electrolyte secondary battery according to the present invention. A commonly employed microporous polymer film can be used as a separator with no particular restriction. Polymer materials providing a microporous film separator include polyethylene, polypropylene, polyvinylidene fluoride, polyvinylidene chloride, polyacrylonitrile, polyacrylamide, polytetrafluoroethylene, polysulfone, polyether sulfone, polycarbonate, polyamide, polyimide, polyethers such as polyethylene oxide and polypropylene oxide, celluloses such as carboxymethyl cellulose and hydroxypropyl cellulose, poly(metha)acrylic acid and esters thereof; derivatives of these polymers; copolymers of monomers of the recited polymers; and polyblends of these polymer materials. The separator may be a single film or a composite film composed of two or more films. Various additives may be added to the separator film with no particular limitation on the kind and amount. A film made of polyethylene, polypropylene, polyvinylidene fluoride or polysulfone is particularly preferred for use in the nonaqueous electrolyte secondary battery of the invention.

The separator film is microporous for allowing the electrolyte ions to penetrate therethrough. Such a microporous film is prepared by (1) a phase separation method comprising inducing microphase separation in a solution of a polymer in a solvent in film form and removing the solvent by extraction and (2) a stretching method comprising extruding a molten polymer at a high draft ratio, heat treating the extruded film to unidirectionally align the crystals, and stretching the film to form voids between crystals. The method of microporous film formation is chosen according to the film material.

In order to ensure safety of the nonaqueous electrolyte secondary battery of the invention, the electrode materials, nonaqueous electrolyte, and separator may contain a phenol antioxidant, a phosphorus antioxidant, a thioether antioxidant, a hindered amine compound, etc. According to a need, other additives than the silicon compound of the present invention, such as vinylene carbonate (VC), may be added to the nonaqueous electrolyte within a range of from 0.05% to 5% by volume based on the nonaqueous electrolyte.

The phenol antioxidant includes 1,6-hexamethylenebis[(3-tert-butyl-5-methyl-4-hydroxyphenyl)propionamide], 4,4′-thiobis(6-tert-butyl-m-cresol), 4,4′-butylidenebis(6-tert-butyl-m-cresol), 1,1,3-tris(2-methyl-4-hydroxy-5-tert-butylphenyl)butane, 1,3,5-tris(2,6-dimethyl-3-hydroxy-4-tert-butylbenzyl) isocyanurate, 1,3,5-tris(3,5-di-tert-butyl-4-hydroxybenzyl) isocyanurate, 1,3,5-tris(3,5-di-tert-butyl-4-hydroxybenzyl)-2,4,6-trimethylbenzene, tetrakis[methylene-3-(3,5-di-tert-butyl-4-hydroxyphenyl)propionate]methane, thiodiethylene glycol bis[(3,5-di-tert-butyl4-hydroxyphenyl)propionate], 1,6-hexamethylenebis[(3,5-di-tert-butyl-4-hydroxyphenyl)propionate], bis[3,3-bis(4-hydroxy-3-tert-butylphenyl)butyric acid] glycol ester, bis[2-tert-butyl4-methyl-6-(2-hydroxy-3-tert-butyl-5-methylbenzyl)phenyl] terephthalate, 1,3,5-tris[(3,5-di-tert-butyl4-hydroxyphenyl)propionyloxyethyl] isocyanurate, 3,9-bis[1,1-dimethyl-2-{(3-tert-butyl-4-hydroxy-5-methylphenyl)propionyloxy}ethyl]-2,4,8,10-tetraoxaspiro[5,5]undecane, and triethylene glycol bis[(3-tert-butyl-4-hydroxy-5-methylphenyl)propionate]. When added to an electrode material, the phenol antioxidant is preferably used in an amount of 0.01 to 10 parts by mass, still preferably 0.05 to 5 parts by mass, per 100 parts by mass of the electrode material.

The phosphorus antioxidant includes trisnonylphenyl phosphite, tris[2-tert-butyl-4-(3-tert-butyl-4-hydroxy-5-methylphenylthio)-5-methylphenyl] phosphite, tridecyl phosphite, octyldiphenyl phosphite, di(decyl)monophenyl phosphite, di(tridecyl) pentaerythritol diphosphite, di(nonylphenyl) pentaerythritol diphosphite, bis(2,4-di-tert-butylphenyl) pentaerythritol diphosphite, bis(2,6-di-t-butyl-4-methylphenyl) pentaerythritol diphosphite, bis(2,4,6-tri-tert-butylphenyl) pentaerythritol diphosphite, bis(2,4-dicumylphenyl) pentaerythritol diphosphite, tetra(tridecyl)isopropylidenediphenol diphosphite, tetra(tridecyl)-4,4′-n-butylidenebis(2-tert-butyl-5-methylphenol) diphosphite, hexa(tridecyl)-1,1,3-tris(2-methyl-4-hydroxy-5-tert-butylphenyl)butane triphosphite, tetrakis(2,4-di-tert-butylphenyl)biphenylene diphosphonite, 9,10-dihydro-9-oxa-10-phosphaphenanthrene 10-oxide, 2,2-methylenebis(4,6-di-tert-butylphenyl)-2-ethylhexyl phosphite, 2,2′-methylenebis(4,6-di-tert-butylphenyl)-octadecyl phosphite, 2,2′-ethylidenebis(4,6-di-tert-butylphenyl) fluorophosphite, tris(2-[(2,4,8,10-tetrakis-tert-butyldibenzo[d,f][1,3,2]dioxaphosphepin-6-yl)oxy]ethyl)amine, and 2-ethyl-2-butyl propylene glycol 2,4,6-tri-tert-butylphenol phosphite.

The thioether antioxidant includes dialkyl thiodipropionates such as dilauryl thiodipropionate, dimyristyl thiodipropionate, and distearyl thiodipropionate, and a pentaerythritol tetra(β-alkylmercaptopropionate).

The hindered amine compound includes 2,2,6,6-tetramethyl-4-piperidyl stearate, 1,2,2,6,6-pentamethyl-4-piperidyl stearate, 2,2,6,6-tetramethyl-4-piperidyl benzoate, bis(2,2,6,6-tetramethyl4-piperidyl) sebacate, tetrakis(2,2,6,6-tetramethyl-4-piperidyl) 1,2,3,4-butanetetracarboxylate, tetrakis(1,2,2,6,6-pentamethyl-4-piperidyl) 1,2,3,4-butanetetracarboxylate, bis(2,2,6,6-tetramethyl-4-piperidyl)di(tridecyl) 1,2,3,4-butanetetracarboxylate, bis(1,2,2,6,6-pentamethyl-4-piperidyl)di(tridecyl) 1,2,3,4-butanetetracarboxylate, bis(1,2,2,4,4-pentamethyl-4-piperidyl)-2-butyl-2-(3,5-di-tert-butyl-4-hydroxybenzyl) malonate, 1-(2-hydroxyethyl)-2,2,6,6-tetramethyl-4-piperidinol/diethyl succinate polycondensate, 1,6-bis(2,2,6,6-tetramethyl-4-piperidylamino)hexane/2,4-dichloro-6-morpholino-s-triazine polycondensate, 1,6-bis(2,2,6,6-tetramethyl-4-piperidylamino)hexane/2,4-dichloro-6-tert-octylamino-s-triazine polycondensate, 1,5,8,12-tetrakis[2,4-bis(N-butyl-N-(2,2,6,6-tetramethyl-4-piperidyl)amino)-s-triazin-6-yl]-1,5,8,12-tetraazadodecane, 1,5,8,12-tetrakis[2,4-bis(N-butyl-N-(1,2,2,6,6-pentamethyl4-piperidyl)amino)-s-triazin-6-yl]-1,5,8,12-tetraazadodecane, 1,6,11-tris[2,4-bis(N-butyl-N-(2,2,6,6-tetramethyl-4-piperidyl)amino)-s-triazin-6-yl]aminoundecane, and 1,6,11-tris[2,4-bis(N-butyl-N-(1,2,2,6,6-pentamethyl4-piperidyl)amino)-s-triazin-6-yl] aminoundecane.

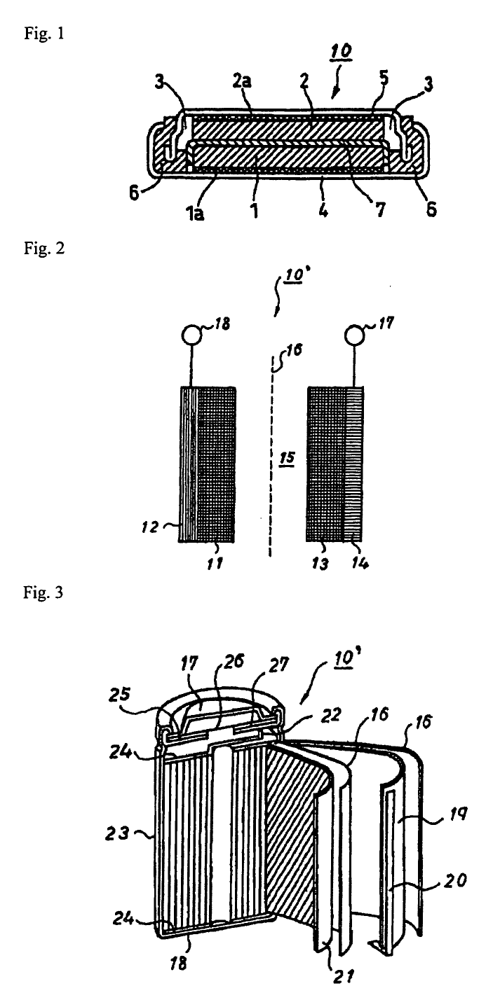

The nonaqueous electrolyte secondary battery of the invention is not particularly limited in shape and may be coin-shaped, cylindrical or rectangular. FIG. 1 illustrates an example of a coin-shaped nonaqueous electrolyte secondary battery of the invention, and FIGS. 2 and 3 each illustrate an example of a cylindrical nonaqueous electrolyte secondary battery of the invention.

The coin battery 10 illustrated in FIG. 1 has a positive electrode 1 capable of deintercalating lithium ions, a positive electrode current collector 1a, a negative electrode 2 made of a carbonaceous material capable of intercalating/deintercalating lithium ions released from the negative electrode, a positive electrode current collector 2a, a nonaqueous electrolyte 3 according to the invention, a positive electrode case 4 made of stainless steel, a negative electrode case 5 made of stainless steel, a polypropylene gasket 6, and a polyethylene separator 7.

As illustrated in FIG. 2, the cylindrical battery 10′ is basically composed of a negative electrode 11, a negative electrode current collector 12, a positive electrode 13, a positive electrode current collector 14, a nonaqueous electrolyte 15 of the present invention, a separator 16, a positive electrode terminal 17, and a negative electrode terminal 18. More specifically, as illustrated in FIG. 3, the battery 10′ has a negative electrode plate 19, a negative electrode lead 20, a positive electrode plate 21, a positive electrode lead 22, a case 23, an insulating plate 24, a gasket 25, a safety valve 26, and a PTC element 27.

The present invention will now be illustrated in greater detail with reference to Examples, but it should be understood that the invention is not construed as being limited thereto. Unless otherwise noted, all the parts are by weight.

In Examples and Comparative Examples, nonaqueous electrolyte lithium secondary batteries were produced as follows.

(1) Preparation of Positive Electrode

A positive active material mixture of 85 parts of LiNiO₂ (positive electrode active material), 10 parts of acetylene black (conductive material), and 5 parts of polyvinylidene fluoride (PVDF) (binder) was dispersed in N-methyl-2-pyrrolidone (NMP) to prepare a slurry. The slurry was coated to both sides of an aluminum current collector, dried, and pressed to make a positive electrode plate. The resulting plate was cut to size, and the applied active material mixture was scraped off from a part where a lead tab for collecting electric current was to be welded to prepare a sheet positive electrode.

(2) Preparation of Negative Electrode

A negative active material mixture of 92.5 parts of a carbon material powder (negative electrode active material) and 7.5 parts of PVDF (binder) was dispersed in NMP to prepare a slurry. The slurry was coated to both sides of a copper current collector, dried, and pressed to obtain a negative electrode plate. The plate was cut to size, and the applied active material mixture was scraped off from a part where a lead tab for collecting electric current was to be welded to prepare a sheet negative electrode.

(3) Preparation of Nonaqueous Electrolyte

In a mixed organic solvent was dissolved LiPF₆ in a concentration of 1 mol/l, and a test compound shown in Table 1 was added thereto in the amount shown to prepare a nonaqueous electrolyte.

(4) Battery Assembly

The sheet positive electrode and the sheet negative electrode were superposed on each other with a 25 μm thick polyethylene microporous film interposed between them and rolled into a spiral electrode assembly, which was put in a case. The lead one end of which was welded to the part of the positive or negative electrode where the active material mixture had been scraped off was joined to the positive or negative electrode terminal of the case, respectively. The nonaqueous electrolyte was poured into the case having the spiral electrode assembly, and the case was closed and sealed to produce a cylindrical lithium secondary battery having a diameter of 18 mm and an axial length of 65 mm.

### EXAMPLES 1-1 TO 1-12 AND COMPARATIVE EXAMPLES 1-1 TO 1-5

LiPF₆ was dissolved in a mixed solvent consisting of 30 vol % of ethylene carbonate, 40 vol % of ethyl methyl carbonate, and 30 vol % of dimethyl carbonate in a concentration of 1 mol/l, and the test compound shown in Table 1 below was added to the solution to prepare a nonaqueous electrolyte.

A lithium secondary battery was assembled using the resulting nonaqueous electrolyte. The resulting battery was evaluated for (1) a discharge capacity retention (%) and (2) an internal resistance increase (%) by testing of cyclic characteristics and for (3) discharge capacity ratio (%) and (4) internal resistance ratio (%) by testing of low temperature characteristics in accordance with the following test methods. Cycle characteristics test method:

The lithium secondary battery was placed in a thermostat at 60° C. and charged at a constant current of 2.2 mA/cm² to 4.1 V and then discharged at a constant current of 2.2 mA/cm² to 3 V (cycled) for a total of 500 cycles. Thereafter, the battery was charged by the current density/current voltage (CC/CV) method at 1.1 mA/cm² to 4.1 V and then discharged at a constant current of 0.33 mA/cm² to 3.0 V at an ambient temperature of 20° C. The charge capacity retention (%) was obtained from the initial discharge capacity and the discharge capacity after 500 cycles according to equation shown below. The internal resistance at 20° C. was measured before and after 500 cycles to obtain an internal resistance increase (%) according to equation below. The initial discharge capacity and internal resistance were measured as follows.
Discharge capacity retention (%)=(discharge capacity after cycles/initial discharge capacity)×100
Internal resistance increase (%)=(internal resistance after cycles/internal resistance before cycles)×100
Measurement of Initial Discharge Capacity:

The battery was charged by the CC/CV method (constant current of 0.25 mA/cm² to 4.1 V) and then discharged at a constant current of 0.33 mA/cm² to 3.0 V. Thereafter, the battery was charged by the CC/CV method at 1.1 mA/cm² to 4.1 V and discharged at a constant current of 1.1 mA/cm² to 3.0 V (cycled) for a total of four cycles. Finally, the battery was charged by the CC/CV mode at 1.1 mA/cm² to 4.1 V and discharged at 0.33 mA/cm² to 3.0 V, and the discharge capacity in this discharge was taken as the initial capacity of the battery. The measurement was made at 20° C.

Measurement of Internal Resistance:

The battery was charged by the CC/CV method (constant current of 1.1 mA/cm² to 3.75 V). The impedance was measured over a frequency range of from 100 kHz to 0.02 Hz using an alternating current impedance measurement system (a frequency response analyzer Solartron 1260 and a potentio/garvanostat Solartron 1287, both available from Toyo Corp.) to prepare a Cole-Cole plot with the imaginary part as ordinate and the real part abscissa. The arc of the Cole-Cole plot was fitted with a circle. The greater value of the two intersections between the fitting circle and the real part (abscissa) is taken as the internal resistance of the battery.

Low Temperature Characteristics Test Method:

The discharge capacity at 20° C. was measured in the same manner as in the above-described measurement of initial discharge capacity. The discharge capacity at −30° C. was measured in the same manner but changing the measuring temperature to −30° C. A discharge capacity ratio (%) was obtained from the discharge capacities at 20° C. and −30° C. according to equation below.

Internal resistance at 20° C. and −30° C. were measured in the same manner as in the above-described cycle characteristics test to calculate an internal resistance ratio according to equation below.
Discharge capacity ratio (%)=(discharge capacity at −30° C./discharge capacity at 20° C.)×100
Internal resistance ratio=internal resistance at −30° C./internal resistance at 20° C.

The results of the cycle characteristics test and the low temperature characteristics test are shown in Table 1. While not shown in Table 1, the initial discharge capacity in Examples 1-1 to 1-12 and Comparative Examples 1-2 to 1-5 was equal to or higher than that in Comparative Example 1-1.

TABLE 1

| | | | | | Cycle Characteristics | | Low Temperature | |
|---|---|---|---|---|---|---|---|---|
| | Test | | | | Discharge | Internal | Characteristics | |
| | Compound | | | | Capacity | Resistance | Discharge | Internal |
| | Compound | Amount | Other Test | Amount | Retention | Increase | Capacity | Resistance |
| | No. | (vol%) | Compound | (vol%) | (%) | (%) | Ratio (%) | Ratio |
| Example 1-1 | 1 | 0.6 | — | — | 96.5 | 120 | 89 | 9.8 |
| Example 1-2 | 4 | 0.6 | — | — | 97.2 | 117 | 93 | 9.2 |
| Example 1-3 | 5 | 0.6 | — | — | 96.8 | 118 | 91 | 8.9 |
| Example 1-4 | 5 | 1.0 | — | — | 97.0 | 116 | 93 | 8.4 |
| Example 1-5 | 8 | 0.6 | — | — | 97.1 | 115 | 93 | 9.2 |
| Example 1-6 | 9 | 0.6 | — | — | 97.1 | 112 | 92 | 8.9 |
| Example 1-7 | 10 | 0.6 | — | — | 96.9 | 113 | 91 | 8.1 |
| Example 1-8 | 12 | 0.6 | — | — | 96.5 | 118 | 92 | 8.8 |
| Example 1-9 | 14 | 0.6 | — | — | 97.9 | 116 | 91 | 9.3 |
| Example 1-10 | 25 | 0.6 | — | — | 97.5 | 112 | 93 | 8.4 |
| Example 1-11 | 5 | 0.6 | VC | 0.5 | 96.8 | 115 | 90 | 8.0 |
| Example 1-12 | 25 | 0.6 | VC | 0.5 | 97.6 | 110 | 94 | 7.8 |
| Comparative | none | — | — | — | 78.0 | 153 | 58 | 18.1 |
| Example 1-1 | | | | | | | | |
| Comparative | 1 | 0.6 | — | — | 87.2 | 136 | 78 | 13.1 |
| Example 1-2 | | | | | | | | |
| Comparative | 2 | 0.6 | — | — | 90.9 | 131 | 81 | 12.5 |
| Example 1-3 | | | | | | | | |
| Comparative | 3 | 0.6 | — | — | 75.5 | 177 | 48 | 21.4 |
| Example 1-4 | | | | | | | | |
| Comparative | none | — | VC | 0.5 | 85.5 | 142 | 77 | 16.9 |
| Example 1-5 | | | | | | | | |

Comparative compound 1:

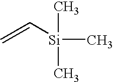

Comparative compound 2:

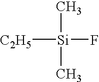

Comparative compound 3:

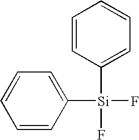

As is apparent from the results in Table 1, the nonaqueous electrolyte secondary batteries of Examples 1-1 to 1-12 using the nonaqueous electrolyte of the invention, which contained the silicon compound of formula (1) or (2), were proved excellent in low temperature characteristics and cycle characteristics. Although the nonaqueous electrolyte secondary batteries of Comparative Examples 1-2 and 1-3 using a nonaqueous electrolyte containing a comparative compound showed improvement in initial low temperature characteristics and cycle characteristics over the battery using a nonaqueous electrolyte containing no test compound (Comparative Example 1-1 and 1-5), they were still insufficient compared with the batteries of the invention.

### INDUSTRIAL APPLICABILITY

As described, the present invention provides a nonaqueous secondary battery using a nonaqueous electrolyte containing a silicon compound having a specific structure and therefore excellent in cycle characteristics and low temperature characteristics.

1. A nonaqueous electrolyte having an electrolyte salt dissolved in an organic solvent and containing at least one silicon compound represented by formula (1) or (2): 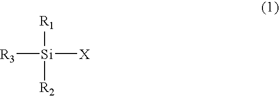
wherein R₁ and R₂ each represent an alkyl group having 1 to 10 carbon atoms, a cycloalkyl group having 5 to 8 carbon atoms, an alkoxy group having 1 to 10 carbon atoms or a halogen atom; R₃ represents an alkenyl group having 13 to 20 carbon atoms; and X represents a halogen atom. 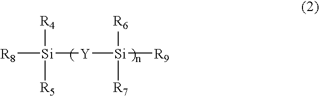
wherein R₄, R₅, R₆, and R₇ each represent an alkyl group having 1 to 10 carbon atoms, an alkoxy group having 1 to 10 carbon atoms, an alkenyl group having 2 to 10 carbon atoms, an alkenyloxy group having 2 to 10 carbon atoms, an alkynyl group having 2 to 8 carbon atoms, an alkynyloxy group having 2 to 8 carbon atoms, a phenyl group or a phenoxy group, each of which may have an ether bond in its chain; R₈ represents a halogen atom, a halogen-substituted aryl group, an alkenyl group having 2 to 20 carbon atoms, an alkynyl group having 2 to 8 carbon atoms, a cycloalkyl group having 5 to 8 carbon atoms, a cycloalkenyl group having 5 to 8 carbon atoms; a trifluoromethyl group,an acyloxy group having 5 to 8 carbon atoms, a sulfonate group having 1 to 8 carbon atoms, an isocyanyl group an isothianyl or a cyano group, R₉ represents a halogen atom, a halogen-substituted aryl group; a trifluoromethyl group, an acyloxy group having 5 to 8 carbon atoms, a sulfonate group having 1 to 8 carbon atoms, an isocyanyl group an isothianyl or a cyano group, n represents 1 or 2; Y represents a single bond, an oxygen atom, an alkylene group, an alkylenedioxy group, an alkenylene group, an alkenylenedioxy group, an alkynylene group, an alkynylenedioxy group, an arylene group or an arylenedioxy group; and the number of groups having an unsaturated bond in R₄, R₅, R₆, R₇, R₈, and R₉ is zero or one.

2. The nonaqueous electrolyte according to claim 1, wherein X is a fluorine atom; R₁ and R₂ are each a methyl group; and R₃ is an alkenyl group having 13 carbon atoms.

3. The nonaqueous electrolyte according to claim 1, wherein X and R₁ are each a fluorine atom; R₂ is a methyl group; and R₃ is an alkenyl group having 13 carbon atoms.

4. The nonaqueous electrolyte according to claim 1, wherein Y is an ethenylene group; and R₈ and R₉ are each a fluorine atom.

5. The nonaqueous electrolyte according to claim 1, wherein Y is an ethynylene group; and R₈ and R₉ are each a fluorine atom.

6. The nonaqueous electrolyte according to claim 1, wherein Y is a single bond; R₈ is an ethynyl group; and R₉ is a fluorine-substituted aryl group.

7. The nonaqueous electrolyte according to claim 1, wherein Y is a single bond; R₈ is a fluorine-substituted aryl group; and R₉ is a fluorine atom.

8. The nonaqueous electrolyte according to claim 1, wherein Y is a single bond; R₈ is a vinyl group; and R₉ is a fluorine atom.

9. The nonaqueous electrolyte according to claim 1, wherein Y is a single bond; and R₈ and R₉ are each a fluorine-substituted aryl group.

10. The nonaqueous electrolyte according to claim 1, wherein Y is an ethylene group; and R₈ and R₉ are each a fluorine atom.

11. The nonaqueous electrolyte according to claim 1, wherein the organic solvent comprises at least one compound selected from the group consisting of a cyclic carbonate compound, an acyclic carbonate compound, a cyclic ester compound, an acyclic ester compound, a sulfone compound, a sulfoxide compound, an amide compound, an acyclic ether compound, and a cyclic ether compound.

12. The nonaqueous electrolyte according to claim 11, wherein the organic solvent comprises a cyclic carbonate compound and an acyclic carbonate compound.

13. The nonaqueous electrolyte according to claim 1, wherein the electrolyte salt is at least one member selected from the group consisting of an inorganic salt consisting of LiPF₆, LiBF₄, LiClO₄, and LiAsF₆, and a organic salt consisting of LiCF₃SO₃, LiN (CF₃SO₂)₂, and LiC (CF₃SO₂)₃.

14. The nonaqueous electrolyte according to claim 1, wherein the silicon compound is present in an amount of 0.05% to 5% by volume based on the nonaqueous electrolyte.

15. A nonaqueous electrolyte secondary battery comprising the nonaqueous electrolyte according to claim 1.
